(19) United States
(12) Patent Application Publication
(10) Pub. No.: US 2023/0240262 A1
(43) Pub. Date: Aug. 3, 2023

(54) AUTOMATIC BATH CLEANING MACHINE FOR PET DOGS

(71) Applicant: Heping Liu, Dongguan (CN)

(72) Inventor: Heping Liu, Dongguan (CN)

(21) Appl. No.: 17/586,815

(22) Filed: Jan. 28, 2022

(51) Int. Cl. A01K 13/00; A01K 1/06

(52) U.S. Cl. CPC A01K 13/001; A01K 1/0613

(57) ABSTRACT

The invention discloses an automatic bath cleaning machine for pet dogs, comprising a frame-type shell, wherein the inside of the frame-type shell is installed with a tub body; the top of the frame-type shell is installed with a metal frame cover; the middle of the metal frame cover is provided with a water spray mechanism; the water spray mechanism comprises a metal base A, a stepping motor A, a water spray pipe A, and a metal base B; the metal base A is fixedly installed on one end of the metal frame cover, and the metal base B is fixedly installed on the other end of the metal frame cover; the top of the metal base A is fixedly installed with the stepping motor A; the top of the stepping motor A is fixedly installed with a synchronous wheel B. The invention improves the efficiency of staff bathing pet dogs.

### BACKGROUND OF THE INVENTION

### 1. Field of the Invention

The invention relates to the technical field of bath cleaning machines for pet dogs, in particular to an automatic bath cleaning machine for pet dogs.

### 2. Description of the Related Art

A pet dog will emit an unpleasant odor from its body if it is not bathed for several days. To get rid of this odor, the pet owner must bathe the pet dog. It takes a lot of time for pet store staff to bathe these medium and large dogs, which is labor-intensive. In the room where the pet dog is bathed, the pet dog has been soaked in hot water, and the smell emitted is unpleasant, and the long-term work has an impact on the respiratory tract of the staff. Therefore, we propose an automatic bath cleaning machine for pet dogs.

### SUMMARY OF THE INVENTION

The purpose of the invention is to provide an automatic bath cleaning machine for pet dogs, so as to solve the problems in the prior art that in the room where the pet dog is bathed, the pet dog has been soaked in hot water, and the smell emitted is unpleasant, and the long-term work has an impact on the respiratory tract of the staff.

In order to achieve the above purpose, the invention provides the following technical solutions: an automatic bath cleaning machine for pet dogs, comprising a frame-type shell, wherein the inside of the frame-type shell is installed with a tub body; the top of the frame-type shell is installed with a metal frame cover; the middle of the metal frame cover is provided with a water spray mechanism; the water spray mechanism comprises a metal base A, a stepping motor A, a water spray pipe A, and a metal base B; the metal base A is fixedly installed on one end of the metal frame cover, and the metal base B is fixedly installed on the other end of the metal frame cover; the top of the metal base A is fixedly installed with the stepping motor A; the top of the stepping motor A is fixedly installed with a synchronous wheel B; the position near the bottom of the metal base A and the position near the bottom of the metal base B are installed with the water spray pipe A and a blower pipe B through roller bearings; the middle of both the water spray pipe A and the blower pipe B is provided with a short pipe;

both sides of the inner wall of the tub body are provided with a strip-shaped air outlet; the outer surface of the strip-shaped air outlet at the position on the inner wall of the tub body is provided with a water blocking door; the inner side of the strip-shaped air outlet is fixedly installed with a swing-type hot air blower located on the outer surface of the tub body; the outside of the water blocking door is fixedly installed with a metal guardrail located on the inner wall of the tub body; the center of the bottom surface of the tub body is provided with a water stirring impeller; the bottom end of the water stirring impeller is fixedly provided with a pulley A located below the tub body; the middle of the bottom surface of the frame-type shell at the position close to the side is fixedly installed with a stepping motor C; the top of the stepping motor C is installed with a pulley D; the pulley D and the pulley A are connected by a belt;

one end of the bottom end of the tub body is provided with a water leakage hole; the bottom surface of the tub body is symmetrically provided with two bar-shaped protrusions, and both ends of each bar-shaped protrusion are provided with a backwater hole; the bottom end of the water leakage hole is connected with a water collecting pipe in seal, and the other end of the water collecting pipe is connected with a water pump.

Preferably, one end of the water spray pipe A is fixedly installed with a synchronous wheel A, and the other end of the water spray pipe A is fixedly installed with a synchronous wheel C; one end of the blower pipe B is fixedly installed with a synchronous wheel D; the synchronous wheel C and the synchronous wheel D are connected by a synchronous belt; the synchronous wheel B at the top of the stepping motor A and the synchronous wheel A at one end of the water spray pipe A are connected by a synchronous belt; an infrared physiotherapy lamp is provided between the axes of the water spray pipe A and the blower pipe B; the infrared physiotherapy lamp is parallel to the axis of the water spray pipe A; both ends of the infrared physiotherapy lamp are respectively fixedly connected to the metal base A and the metal base B.

Preferably, the four end corners of the bottom surface of the frame-type shell are fixedly installed with a brakeable roller; the water blocking door is connected to the inner wall of the tub body through a damping hinge.

Preferably, the tub body is laterally provided with a rotating hot air pipe near the bottom end; the rotating hot air pipe is fixedly provided with a pulley B at one end outside the tub body; the position close to one side of the bottom surface of the frame-type shell is fixedly installed with a stepping motor B; the top of the stepping motor B is installed with a pulley C; the pulley C and the pulley B are connected by a belt.

Preferably, the rotating hot air pipe is connected to the inner wall of the tub body through a waterproof sealing bearing; the surface of the rotating hot air pipe is uniformly provided with through holes in the lateral direction.

Preferably, one end of the rotating hot air pipe is connected with a hot air pipe joint through a T-shaped limiter, and the other end of the rotating hot air pipe is connected with a water pipe joint through a T-shaped limiter; the inside of the rotating hot air pipe at the position close to the hot air pipe joint is provided with a water blocking valve; the water blocking valve comprises a fixing plate, and the fixing plate is fixed on the inner wall of the rotating hot air pipe; the surface of the fixing plate is provided with a circle of circular holes close to the outside; the axial position on one side of the fixing plate is connected with a compression spring; the other end of the compression spring is fixedly connected with a baffle plate; the baffle plate abuts against the connection between the rotating hot air pipe and the hot air pipe joint, and completely blocks the circular holes through which the rotating hot air pipe and the hot air pipe joint are connected.

Preferably, one end of both the water spray pipe A and the blowing pipe B is provided with a hose A; the other end of the water pump is connected to the four backwater holes through the hose A connecting the water distributor and the water spray pipe A; the hose of the blower pipe B is connected to the air outlet of one of the swing-type hot air blowers; the bottom end of the water collecting pipe is provided with a drain outlet, and the drain outlet is in threaded connection by a sealing cover.

Preferably, the outside of the water stirring impeller at the position on the bottom surface of the tub body is fixedly installed with a metal protective net.

Compared with the prior art, the advantageous effects of the invention are:

1. the invention releases hot water into the tub body by using the shower to rinse the dog; the user turns on the stepping motor C, and drives the pulley A and the water stirring impeller to rotate through the rotation of the pulley D, so that the water inside the tub body rotates, which is convenient for cleaning; in addition, the synchronous wheel A outside the water stirring impeller can not only protect the water stirring impeller from hurting the dog, but also can limit the dog's movement with the metal guardrail and the metal frame cover, which prevents the dog from moving randomly in the tub body and improves the work efficiency of the staff;

2. in the invention, the user turns on the water pump to transport the hot water inside the tub body along the water leakage hole and the water collecting pipe to the four backwater holes and the water spray pipe A, and the user can turn on the stepping motor A to make it reciprocate, thereby driving the water spray pipe A and the blower pipe B to reciprocate in small amplitudes, so as to spray water on the dog's back and neck; the hot water circulation can effectively save water; after cleaning, the user turns off the water pump, opens the water blocking door, and opens the swing-type hot air blowers; the swing-type hot air blowers on both sides blows and dries the hair of the dog's abdomen; the blower pipe B at the top swings back and forth slightly to blow the hair on the back of the dog, and the user can turn on the infrared physiotherapy lamp while drying the pet's hair to remove germs by infrared rays to promote the skin to heal;

3. the rotating hot air pipe of the invention can perform rotary water spraying and rotary blowing on the crotch position of the pet; the hot air pipe joint is connected to the blower pipe, and the water pipe joint is connected to the water spray pipe; when hot air is blown at the hot air pipe joint, the baffle plate will be pushed to the left, that is, the compression spring will be compressed by the wind; the hot air passes through the gap between the baffle plate and the inner wall of the pipe, enters the interior of the rotating hot air pipe through the circular holes of the fixing plate, and is blown out through the through holes on the surface of the rotating hot air pipe; the user turns off the fan connected to the hot air pipe joint, and the baffle plate will be pressed against the connection between the rotating hot air pipe and the hot air pipe joint again due to the compression spring, and completely block the circular holes through which the rotating hot air pipe and the hot air pipe joint are connected; at this time, the user turns on the water pump connected to the water pipe joint and pours the hot water into the interior of the rotating hot air pipe along the water pipe joint, and then the hot water is sprayed through the through holes on the surface of the rotating hot air pipe.

### BRIEF DESCRIPTION OF THE PREFERRED EMBODIMENTS

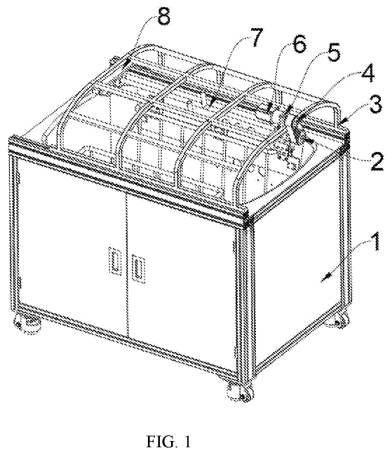

FIG. 1 is a schematic structural diagram of the right side view of the overall top according to the invention;

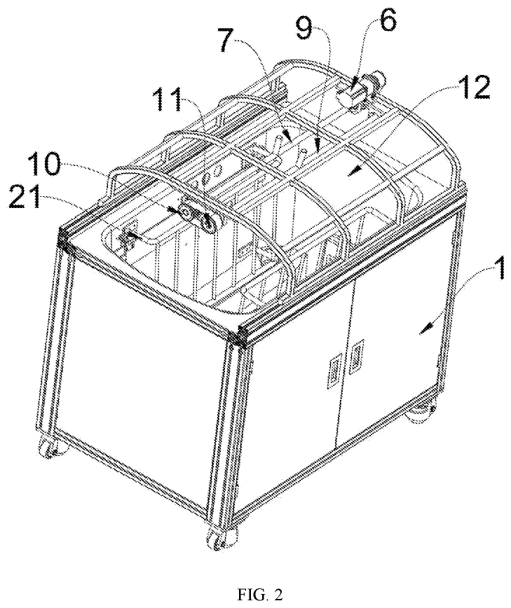

FIG. 2 is a schematic structural diagram of the left side view of the overall top according to the invention;

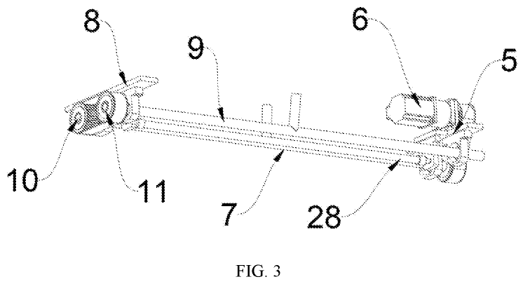

FIG. 3 is the partial structure schematic diagram of the water spray mechanism according to the invention;

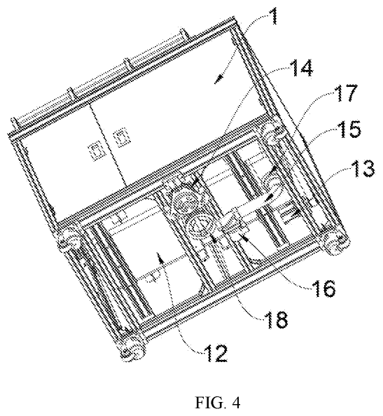

FIG. 4 is a schematic structural diagram of the bottom right side of the frame-type shell according to the invention;

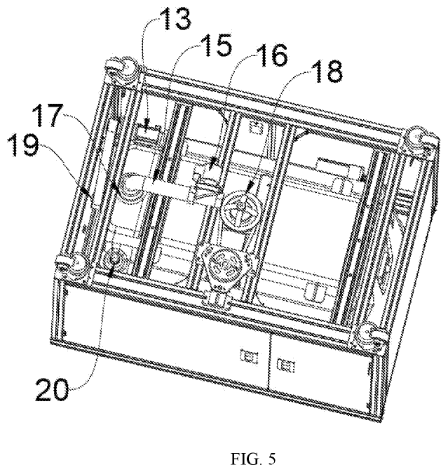

FIG. 5 is a schematic structural diagram of the bottom left side of the frame-type shell according to the invention;

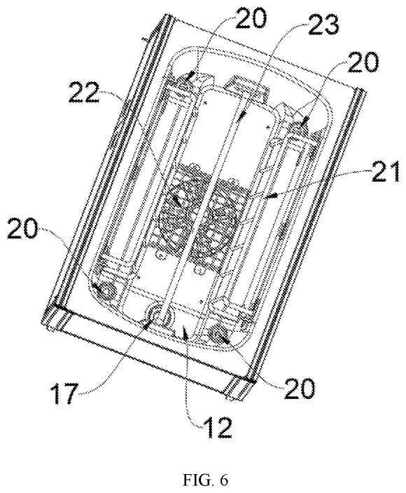

FIG. 6 is a top-view structural schematic diagram of the tub body according to the invention;

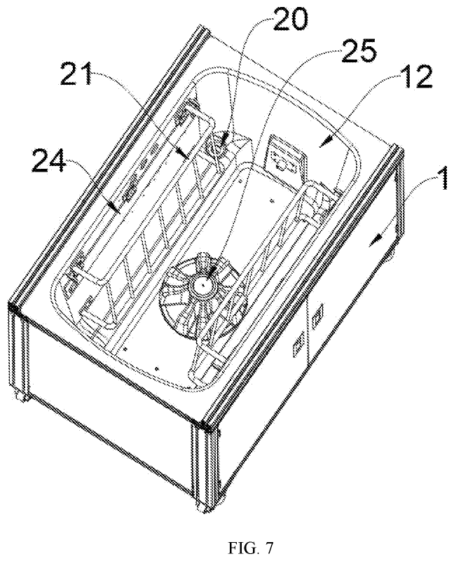

FIG. 7 is a schematic diagram of the structure of the tub body in the state of removing the metal protective net according to the invention;

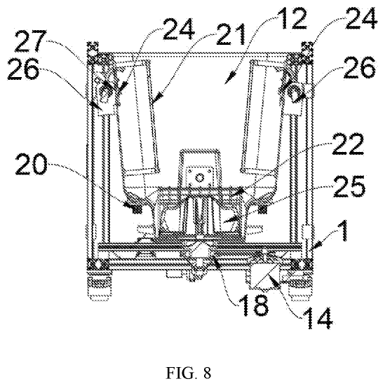

FIG. 8 is a side view of the internal structure schematic diagram of the frame-type shell according to the invention;

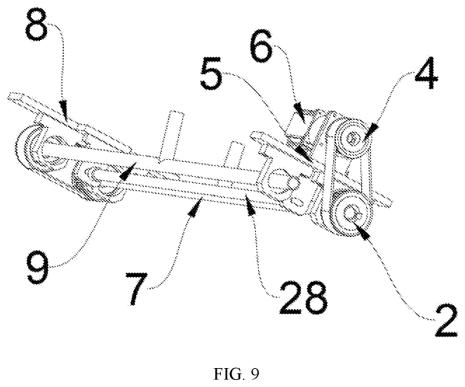

FIG. 9 is a schematic structural diagram of the rear side view of the water spray mechanism according to the invention;

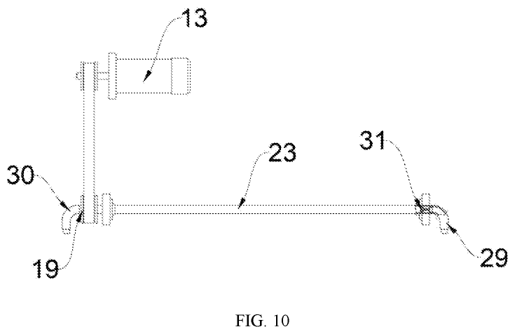

FIG. 10 is a schematic structural diagram of the rotating hot air pipe according to the invention;

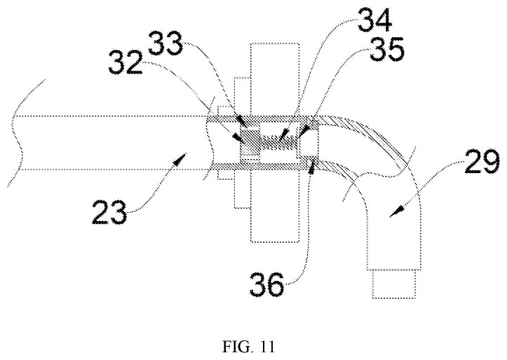

FIG. 11 is the partial structure schematic diagram of the rotating hot air pipe according to the invention.

In the figures, 1 refers to the frame-style shell; 2 refers to the synchronous wheel A; 3 refers to the metal frame cover; 4 refers to the synchronous wheel B; 5 refers to the metal base A; 6 refers to the stepping motor A; 7 refers to the water spray pipe A; 8 refers to the metal base B; 9 refers to the blower pipe B; 10 refers to the synchronous wheel C; 11 refers to the synchronous wheel D; 12 refers to the tub body; 13 refers to the stepping motor B; 14 refers to the stepping motor C; 15 refers to the water collecting pipe; 16 refers to the water pump; 17 refers to the water leakage hole; 18 refers to the pulley A; 19 refers to the pulley B; 20 refers to the backwater hole; 21 refers to the metal guardrail; 22 refers to the metal protective net; 23 refers to the rotating hot air pipe; 24 refers to the water blocking door; 25 refers to the water stirring impeller; 26 refers to the swing-type hot air blower; 27 refers to the strip-shaped air outlet; 28 refers to the infrared physiotherapy lamp; 29 refers to the hot air pipe joint; 30 refers to the water pipe joint; 31 refers to the water blocking valve; 32 refers to the fixing plate; 33 refers to the circular hole; 34 refers to the compression spring; 35 refers to the baffle plate; 36 refers to the T-shaped limiter.

### DETAILED DESCRIPTION OF THE PREFERRED EMBODIMENTS

The technical solutions in the embodiments of the invention will be clearly and completely described hereinafter with reference to the drawings of the invention. Obviously, the described embodiments are part of the embodiments of the invention, rather than all of the embodiments.

With reference to FIGS. 1-11, the invention provides an embodiment: an automatic bath cleaning machine for pet dogs, comprising a frame-type shell 1, wherein the inside of the frame-type shell 1 is installed with a tub body 12; the top of the frame-type shell 1 is installed with a metal frame cover 3; the middle of the metal frame cover 3 is provided with a water spray mechanism; the water spray mechanism comprises a metal base A 5, a stepping motor A 6, a water spray pipe A 7, and a metal base B 8; the metal base A 5 is fixedly installed on one end of the metal frame cover 3, and the metal base B 8 is fixedly installed on the other end of the metal frame cover 3; the top of the metal base A 5 is fixedly installed with the stepping motor A 6; the top of the stepping motor A 6 is fixedly installed with a synchronous wheel B 4; the position near the bottom of the metal base A 5 and the position near the bottom of the metal base B 8 are installed with the water spray pipe A 7 and a blower pipe B 9 through roller bearings; the middle of both the water spray pipe A 7 and the blower pipe B 9 is provided with a short pipe;

both sides of the inner wall of the tub body 12 are provided with a strip-shaped air outlet 27; the outer surface of the strip-shaped air outlet 27 at the position on the inner wall of the tub body 12 is provided with a water blocking door 24; the inner side of the strip-shaped air outlet 27 is fixedly installed with a swing-type hot air blower 26 located on the outer surface of the tub body 12; the outside of the water blocking door 24 is fixedly installed with a metal guardrail 21 located on the inner wall of the tub body 12; the center of the bottom surface of the tub body 12 is provided with a water stirring impeller 25; the bottom end of the water stirring impeller 25 is fixedly provided with a pulley A 18 located below the tub body 12; the middle of the bottom surface of the frame-type shell 1 at the position close to the side is fixedly installed with a stepping motor C 14; the top of the stepping motor C 14 is installed with a pulley D; the pulley D and the pulley A 18 are connected by a belt;

one end of the bottom end of the tub body 12 is provided with a water leakage hole 17; the bottom surface of the tub body 12 is symmetrically provided with two bar-shaped protrusions, and both ends of each bar-shaped protrusion are provided with a backwater hole 20; the bottom end of the water leakage hole 17 is connected with a water collecting pipe 15 in seal, and the other end of the water collecting pipe 15 is connected with a water pump 16.

Further, one end of the water spray pipe A 7 is fixedly installed with a synchronous wheel A 2, and the other end of the water spray pipe A 7 is fixedly installed with a synchronous wheel C 10; one end of the blower pipe B 9 is fixedly installed with a synchronous wheel D 11; the synchronous wheel C 10 and the synchronous wheel D 11 are connected by a synchronous belt; the synchronous wheel B 4 at the top of the stepping motor A 6 and the synchronous wheel A 2 at one end of the water spray pipe A 7 are connected by a synchronous belt; an infrared physiotherapy lamp 28 is provided between the axes of the water spray pipe A 7 and the blower pipe B 9; the infrared physiotherapy lamp 28 is parallel to the axis of the water spray pipe A 7; both ends of the infrared physiotherapy lamp 28 are respectively fixedly connected to the metal base A 5 and the metal base B 8.

Further, the four end corners of the bottom surface of the frame-type shell 1 are fixedly installed with a brakeable roller; the water blocking door 24 is connected to the inner wall of the tub body 12 through a damping hinge.

Further, the tub body 12 is laterally provided with a rotating hot air pipe 23 near the bottom end; the rotating hot air pipe 23 is fixedly provided with a pulley B 19 at one end outside the tub body 12; the position close to one side of the bottom surface of the frame-type shell 1 is fixedly installed with a stepping motor B 13; the top of the stepping motor B 13 is installed with a pulley C; the pulley C and the pulley B 19 are connected by a belt.

Further, the rotating hot air pipe 23 is connected to the inner wall of the tub body 12 through a waterproof sealing bearing; the surface of the rotating hot air pipe 23 is uniformly provided with through holes in the lateral direction.

Further, one end of the rotating hot air pipe 23 is connected with a hot air pipe joint 29 through a T-shaped limiter 36, and the other end of the rotating hot air pipe 23 is connected with a water pipe joint 30 through a T-shaped limiter 36; the inside of the rotating hot air pipe 23 at the position close to the hot air pipe joint 29 is provided with a water blocking valve 31; the water blocking valve 31 comprises a fixing plate 32, and the fixing plate 32 is fixed on the inner wall of the rotating hot air pipe 23; the surface of the fixing plate 32 is provided with a circle of circular holes 33 close to the outside; the axial position on one side of the fixing plate 32 is connected with a compression spring 34; the other end of the compression spring 34 is fixedly connected with a baffle plate 35; the baffle plate 35 abuts against the connection between the rotating hot air pipe 23 and the hot air pipe joint 29, and completely blocks the circular holes through which the rotating hot air pipe 23 and the hot air pipe joint 29 are connected.

Further, one end of both the water spray pipe A 7 and the blowing pipe B 9 is provided with a hose A; the other end of the water pump 16 is connected to the four backwater holes 20 through the hose A connecting the water distributor and the water spray pipe A 7; the hose of the blower pipe B 9 is connected to the air outlet of one of the swing-type hot air blowers 26; the bottom end of the water collecting pipe 15 is provided with a drain outlet, and the drain outlet is in threaded connection by a sealing cover.

Further, the outside of the water stirring impeller 25 at the position on the bottom surface of the tub body 12 is fixedly installed with a metal protective net 22.

Working principle: when in use, the user opens the metal frame cover 3, puts the dog to be cleaned into the tub body 12, closes the metal frame cover 3 and fastens and locks the metal frame cover 3, pacifies the dog and at the same time uses the shower to wash the dog while pouring hot water into the tub body 12; the user turns on the stepping motor C 14, and drives the pulley A 18 and the water stirring impeller 25 to rotate through the rotation of the pulley D, so that the water inside the tub body 12 rotates, which is convenient for cleaning; in addition, the synchronous wheel A 2 outside the water stirring impeller 25 can not only protect the water stirring impeller 25 from hurting the dog, but also can limit the dog's movement with the metal guardrail 21 and the metal frame cover 3, which prevents the dog from moving randomly in the tub body 12 and improves the work efficiency of the staff; the user turns on the water pump 16 to transport the hot water inside the tub body 12 along the water leakage hole 17 and the water collecting pipe 15 to the four backwater holes 20 and the water spray pipe A 7, and the user can turn on the stepping motor A 6 to make it reciprocate, thereby driving the water spray pipe A 7 and the blower pipe B 9 to reciprocate in small amplitudes, so as to spray water on the dog's back and neck; the hot water circulation can effectively save water; after cleaning, the user turns off the water pump 16, opens the water blocking door 24, and opens the swing-type hot air blowers 26; the swing-type hot air blowers 26 on both sides blows and dries the hair of the dog's abdomen; the blower pipe B 9 at the top swings back and forth slightly to blow the hair on the back of the dog, and the user can turn on the infrared physiotherapy lamp 28 while drying the pet's hair to remove germs by infrared rays to promote the skin to heal; the rotating hot air pipe 23 can perform rotary water spraying and rotary blowing on the crotch position of the pet; the hot air pipe joint 29 is connected to the blower pipe, and the water pipe joint 30 is connected to the water spray pipe; when hot air is blown at the hot air pipe joint 29, the baffle plate 35 will be pushed to the left, that is, the compression spring 34 will be compressed by the wind; the hot air passes through the gap between the baffle plate 35 and the inner wall of the pipe, enters the interior of the rotating hot air pipe 23 through the circular holes 33 of the fixing plate 32, and is blown out through the through holes on the surface of the rotating hot air pipe 23; the user turns off the fan connected to the hot air pipe joint 29, and the baffle plate 35 will be pressed against the connection between the rotating hot air pipe 23 and the hot air pipe joint 29 again due to the compression spring 34, and completely block the circular holes through which the rotating hot air pipe 23 and the hot air pipe joint 29 are connected; at this time, the user turns on the water pump 30 connected to the water pipe joint and pours the hot water into the interior of the rotating hot air pipe 23 along the water pipe joint 30, and then the hot water is sprayed through the through holes on the surface of the rotating hot air pipe 23.

It is obvious to those skilled in the art that the invention is not limited to the details of the above embodiments, and that the invention can be implemented in other specific forms without departing from the spirit or essential characteristics of the invention. Therefore, the embodiments should be regarded as exemplary and non-restrictive from any point of view, and the scope of the invention is defined by the appended claims rather than the above description, it is therefore intended to embrace within the invention all changes that come within the meaning and range of equivalency of the claims. Any reference signs in the claims shall not be construed as limiting the involved claim.

1. An automatic bath cleaning machine for pet dogs, comprising a frame-type shell (1), wherein the inside of the frame-type shell (1) is installed with a tub body (12); the top of the frame-type shell (1) is installed with a metal frame cover (3); the middle of the metal frame cover (3) is provided with a water spray mechanism; the water spray mechanism comprises a metal base A (5), a stepping motor A (6), a water spray pipe A (7), and a metal base B (8); the metal base A (5) is fixedly installed on one end of the metal frame cover (3), and the metal base B (8) is fixedly installed on the other end of the metal frame cover (3); the top of the metal base A (5) is fixedly installed with the stepping motor A (6); the top of the stepping motor A (6) is fixedly installed with a synchronous wheel B (4); the position near the bottom of the metal base A (5) and the position near the bottom of the metal base B (8) are installed with the water spray pipe A (7) and a blower pipe B (9) through roller bearings; the middle of both the water spray pipe A (7) and the blower pipe B (9) is provided with a short pipe;
both sides of the inner wall of the tub body (12) are provided with a strip-shaped air outlet (27); the outer surface of the strip-shaped air outlet (27) at the position on the inner wall of the tub body (12) is provided with a water blocking door (24); the inner side of the strip-shaped air outlet (27) is fixedly installed with a swing-type hot air blower (26) located on the outer surface of the tub body (12); the outside of the water blocking door (24) is fixedly installed with a metal guardrail (21) located on the inner wall of the tub body (12); the center of the bottom surface of the tub body (12) is provided with a water stirring impeller (25); the bottom end of the water stirring impeller (25) is fixedly provided with a pulley A (18) located below the tub body (12); the middle of the bottom surface of the frame-type shell (1) at the position close to the side is fixedly installed with a stepping motor C (14); the top of the stepping motor C (14) is installed with a pulley D; the pulley D and the pulley A (18) are connected by a belt;
one end of the bottom end of the tub body (12) is provided with a water leakage hole (17); the bottom surface of the tub body (12) is symmetrically provided with two bar-shaped protrusions, and both ends of each bar-shaped protrusion are provided with a backwater hole (20); the bottom end of the water leakage hole (17) is connected with a water collecting pipe (15) in seal, and the other end of the water collecting pipe (15) is connected with a water pump (16).

2. The automatic bath cleaning machine for pet dogs according to claim 1, wherein one end of the water spray pipe A (7) is fixedly installed with a synchronous wheel A (2), and the other end of the water spray pipe A (7) is fixedly installed with a synchronous wheel C (10); one end of the blower pipe B (9) is fixedly installed with a synchronous wheel D (11); the synchronous wheel C (10) and the synchronous wheel D (11) are connected by a synchronous belt; the synchronous wheel B (4) at the top of the stepping motor A (6) and the synchronous wheel A (2) at one end of the water spray pipe A (7) are connected by a synchronous belt; an infrared physiotherapy lamp (28) is provided between the axes of the water spray pipe A (7) and the blower pipe B (9); the infrared physiotherapy lamp (28) is parallel to the axis of the water spray pipe A (7); both ends of the infrared physiotherapy lamp (28) are respectively fixedly connected to the metal base A (5) and the metal base B (8).

3. The automatic bath cleaning machine for pet dogs according to claim 1, wherein the four end corners of the bottom surface of the frame-type shell (1) are fixedly installed with a brakeable roller; the water blocking door (24) is connected to the inner wall of the tub body (12) through a damping hinge.

4. The automatic bath cleaning machine for pet dogs according to claim 1, wherein the tub body (12) is laterally provided with a rotating hot air pipe (23) near the bottom end; the rotating hot air pipe (23) is fixedly provided with a pulley B (19) at one end outside the tub body (12); the position close to one side of the bottom surface of the frame-type shell (1) is fixedly installed with a stepping motor B (13); the top of the stepping motor B (13) is installed with a pulley C; the pulley C and the pulley B (19) are connected by a belt.

5. The automatic bath cleaning machine for pet dogs according to claim 4, wherein the rotating hot air pipe (23) is connected to the inner wall of the tub body (12) through a waterproof sealing bearing; the surface of the rotating hot air pipe (23) is uniformly provided with through holes in the lateral direction.

6. The automatic bath cleaning machine for pet dogs according to claim 5, wherein one end of the rotating hot air pipe (23) is connected with a hot air pipe joint (29) through a T-shaped limiter (36), and the other end of the rotating hot air pipe (23) is connected with a water pipe joint (30) through a T-shaped limiter (36); the inside of the rotating hot air pipe (23) at the position close to the hot air pipe joint (29) is provided with a water blocking valve (31); the water blocking valve (31) comprises a fixing plate (32), and the fixing plate (32) is fixed on the inner wall of the rotating hot air pipe (23); the surface of the fixing plate (32) is provided with a circle of circular holes (33) close to the outside; the axial position on one side of the fixing plate (32) is connected with a compression spring (34); the other end of the compression spring (34) is fixedly connected with a baffle plate (35); the baffle plate (35) abuts against the connection between the rotating hot air pipe (23) and the hot air pipe joint (29), and completely blocks the circular holes through which the rotating hot air pipe (23) and the hot air pipe joint (29) are connected.

7. The automatic bath cleaning machine for pet dogs according to claim 1, wherein one end of both the water spray pipe A (7) and the blowing pipe B (9) is provided with a hose A; the other end of the water pump (16) is connected to the four backwater holes (20) through the hose A connecting the water distributor and the water spray pipe A (7); the hose of the blower pipe B (9) is connected to the air outlet of one of the swing-type hot air blowers (26); the bottom end of the water collecting pipe (15) is provided with a drain outlet, and the drain outlet is in threaded connection by a sealing cover.

8. The automatic bath cleaning machine for pet dogs according to claim 1, wherein the outside of the water stirring impeller (25) at the position on the bottom surface of the tub body (12) is fixedly installed with a metal protective net (22).
